(19) United States
(12) Patent Application Publication
(10) Pub. No.: US 2017/0317843 A1
(43) Pub. Date: Nov. 2, 2017

(54) METHOD AND APPARATUS FOR PROVIDING DATA PRODUCED IN A CONFERENCE

(71) Applicant: Unify GmbH & Co. KG, Munchen (DE)

(72) Inventor: Jurgen Brieskorn, Geltendorf (DE)

(21) Appl. No.: 15/641,543

(22) Filed: Jul. 5, 2017

Related U.S. Application Data
(63) Continuation of application No. 14/352,463, filed on Apr. 17, 2014.

(51) Int. Cl. H04L 12/18; H04N 7/14; H04M 3/56; H04M 3/42; H04N 7/15

(52) U.S. Cl. CPC H04L 12/1822; H04M 3/42221; H04N 7/147; H04N 7/152; H04L 12/1831; H04M 3/567; H04M 2201/41; H04M 3/569

(57) ABSTRACT

A method for providing data produced in a conference, in which voice signals from participants in the conference are mixed in a conference bridge, can include provision of a time base that runs concurrently over the duration of the conference and setup of automatic identification of each participant when this participant speaks in the conference. The method also comprises capture of conversation contribution by each speaking participant to a conversation by the participants which is conducted during the conference as speaking time associated with each speaking participant at the conference, association of a time stamp with the speaking time, and production of statistical data by virtue of statistical evaluation of the speaking times of the participants.

### CROSS-REFERENCE TO RELATED APPLICATIONS

This application is the United States national phase under 35 U.S.C. §371 of PCT International Application No. PCT/EP2011/005234, filed on Oct. 18, 2011.

### BACKGROUND OF THE INVENTION

### Field of the Invention

Embodiments may relate to methods for providing data produced in a conference.

Embodiments may also relate to a conference bridge to provide data produced in the conference and the use of a terminal unit to implement the method.

### Background of the Related Art

A conference bridge, like this example provided by OpenScape Unified Communications System of Siemens Enterprise Communications GmbH & Co. KG, currently provides few value-added functions to support the conference alongside the actual mixing of voice signals of the participants in the conference. In the following, a conference bridge is considered a unit that is configured to be used for mixing voice signals of participants in a conference. This conference bridge can take the form of an application on a personal computer, hereinafter abbreviated to PC. This PC is also called a media server or conference server. In this case, the conference bridge is implemented as an application on a PC that functions as a server receiving the respective voice signals from the terminal units of the participants, and then transmits the mixed voice signals to the terminal units of the participants. A terminal unit of a participant can be a telephone terminal, an IP phone, or a PC client, but it could also be other terminal units, e.g., a cellular phone or another server. A conference is considered a teleconference, in particular, when the participants in the conference are not located in the same place that would allow them to communicate with one another without using technical means. Rather, the communication of the participants is handled via a conference bridge by mixing the voice signals of the participants, whereupon the conference can be set up as a teleconference or a video conference, for example. In a teleconference, the participants only communicate by exchanging voice communication, regardless of how the voice signals of the participants are transmitted. Therefore, both a teleconference taking place via landline and a teleconference where one or more participants are communicating with one another via a cellular network can be considered a teleconference.

In addition, it is possible to have a conference in the form of a video conference, in which alongside the exchange of voice signals of the participants, image signals of the participants are also transmitted in real time to the other participants. In the following, however, a conference is also considered application sharing, in which alongside the exchange of voice and image signals of the participants, other media is exchanged with the participants, for example, in the form of the transfer of data between the participants. This data can be shown in real time with the voice and/or image signals of the participants, or shown at a delay to these signals on a display, e.g., a PC monitor. Since higher data rates are required for the simultaneous transmission of voice and/or image and/or data signals than with a conventional teleconference where only voice signals of the participants are transmitted, an intranet or the internet is often used as the transmission medium for application sharing. The voice and/or image and/or data signals here are transmitted from a participant to another participant in the form of data packets. However, a conventional circuit-switched telecommunications/switching system or a combination of a circuit-switched network and a packet-switched network can also be used as the transmission medium of the voice signals mixed by the conference bridge that are transmitted within the conference. ISDN (Integrated Services Digital Network) can, for example, be used as the transmission protocol for a circuit-switched network, while for a packet-switched network, for example, H.323 or TCP/IP (Transmission Control Protocol/Internet Protocol) can be used as the transmission protocol.

One value-added function to support the conference provided by the OpenScape Unified Communications System is voice recognition by highlighting the speaker's name on the participant list for the conference. The voice recognition is handled via a web interface, i.e., an interface to the internet, on the OpenScape Unified Communications System, whereupon hereinafter voice recognition is considered the automatic identification of a participant of the conference using the voice of the participant. On the OpenScape Unified Communications System, the voice recognition shows the speaking participant by displaying the name of the speaking participant in bold in the participant list, while the names of the other participants are displayed in the normal font in the participant list. In addition, the speaking participant that is recognized by the voice recognition can also be indicated by showing a picture of the speaking participant on a user interface of a terminal unit of the conference.

Another value-added function to support the conference is the display of the total conversation time over the duration of the conference. In addition to displaying the total conversation time over the duration of the conference, current conference servers do not provide any other added value regarding detailed statistical analyses. Many participants in a conference, e.g., law firms and/or advertising agencies, however, have an interest in the analysis of partner/project information that can be quantified by conversation time recognition and the statistical conversation interactions derived from this. Common accounting applications make it possible to simply push a button on the telephone terminal to assign individual conversations to a specific account of the person using the telephone.

### BRIEF SUMMARY OF THE INVENTION

The function forming the basis of the invention is a method and an apparatus for providing data produced in a conference that avoids the disadvantages of the prior art and provides additional value-added functions to the participants in the conference. In particular, a method and an apparatus for providing data produced in a conference is declared, which allows easy analysis of the content of the conference exceeding that covered in prior art.

### BRIEF DESCRIPTION OF THE FIGURES

Various embodiments and advantages of the invention are illustrated below in the figures. For improved clarity, the figures are not to scale or shown in their true proportions. Unless otherwise indicated, the same reference numbers in the figures identify the same parts with the same significance.

FIG. 1 shows a chronological sequence of a conversation in a conference with three participants.

FIG. 2 shows a schematic layout of a conference with three participants that is held using a conference server.

FIG. 3a shows a user interface for a conference application according to the invention with enhanced administration and analysis functions.

FIG. 3b shows another user interface of a conference application according to the invention with enhanced administration functions for the event of an active account assignment.

### DETAILED DESCRIPTION OF THE INVENTION

As per the method according to the invention for providing data generated in a conference, in which voice signals from participants in the conference are mixed in a conference bridge, this includes provision of a time basis that runs concurrently over the duration of the conference and setup of automatic identification of each participant when this participant speaks in the conference. A time basis that runs concurrently over the duration of the conference can be provided, for example, using the system time of a conference server, an intranet or the internet, whereupon a mechanical, electric, or electronic clock can be used in the simplest case.

The automatic identification of each participant when this participant speaks in the conference can be implemented using voice recognition as described above where a voice signal of a participant is used to recognize this participant. In addition, the method according to the invention includes capturing a conversation contribution for each speaking participant for a conversion of the participants held in the conference as speaking time associated with each speaking participant in the conference. A speaking time is considered time, during which only one participant in the conference is speaking. In contrast with the speaking time, the conversation time is considered time, during which at least two participants in the conference are speaking at the same time.

Embodiments also may include associating a time stamp with the captured speaking time and generating statistical data with a statistical analysis of the speaking times of the participants. Thus, it not only captures the time of the total conference duration, but also individual portions of time that the participants in the conference take part in a conversation held in the conference with the concurrent time basis using the automatic identification of the participant when this person is speaking in the conference.

Embodiments enable a conference bridge that can run as an application on a conference server to conduct statistical analyses on the level of an individual contribution of a participant to a conversation held in the conference, and provide the statistical data generated from the speaking time of the participants. The statistical data can be generated in real time during the conference, at a delay during the conference, or after the conference is finished. Since the individual contributions of the participants to the conference conversation can be captured, not only can the speaking times of the participants be incorporated into the statistical data, but also a change of speaker, i.e., a change of the speaking participant to another speaking participant. Assigning a time stamp to each speaking time also captures the course of conversation for the conference conversation, whereupon the course of conversation can also be incorporated into generating the statistical data. This allows statistical data to be generated and provided that is based on a participant in the conference or that is based on the interaction between individual participants in the conference with one another.

In a further embodiment, the capturing of speaking time assigned to each speaking participant in the conference includes the following steps: Setting a start time for the speaking time to a first time when a first participant starts speaking; setting a stop time for the speaking time to a second time when the first participant stops speaking when at least one of the following conditions is met: At the second time, the other participants are silent and a first conversation pause occurs after the second time that is as long as or longer than a defined first conversation pause time; at the second time, the other participants are silent and after the second time a second participant starts speaking within a second conversation pause that is shorter than the first conversation pause time; at the second time, a second participant speaks and after the second time, a speaking pause occurs for the first participant that is longer than the defined first speaking pause time. A speaking time for a participant is also defined by a period with a start time occurring at a first time and a stop time occurring at a second time after the first time. The first time begins as soon as one of the participants in the conference starts speaking.

Whenever a participant is identified as starting to speak, a speaking time begins for this participant with the first time the participant starts speaking set as the start time for this speaking time. The second time as the stop time of a speaking time is then only set when the other participants are silent at the second time and a first conversation pause occurs after the second time that is as long as a defined first conversation pause time or longer. The background of this condition is that with a conversation pause, i.e., when no participants of the conference are speaking, the speaking time of a participant must also end if no other participants end the conversation pause. This can be the case when a participant has concluded his or her contribution to the conversation, and after the end of this contribution from the same participant, a new contribution begins, like a new topic, for example.

Another case of setting the stop time of a contribution occurs when the other participants are silent at the second time and after the second time another participant other than the previously speaking participants starts speaking. In this case, the contribution of the participant stops when, after the stop time occurring at the second time, another participant starts speaking within a second conversation pause that is shorter than the first conversation pause time. This condition addresses the case when, after ending a contribution of a participant, another participant starts speaking either immediately or after only a brief conversation pause.

Finally, according to some embodiments of the invention, a stop time of a speaking time for a participant is set when another participant speaks at the second time and a speaking pause occurs for the first participant after the second time that is longer than the defined first speaking pause time. This condition addresses, for example, when another participant interrupts a speaking participant, whereupon then at least two participants are speaking simultaneously and the first speaking participant finishes his or her contribution to the conference conversation. The first speaking pause time, which is determined like the first conversation pause time by a participant, an administrator, or automatically, e.g., using a specified maximum and/or minimum time for a conversation contribution of a participant or by adopting known values from earlier conferences, uniformly or custom for each participant, and/or which can be changed during the conference, can be set to be smaller than the first conversation pause time. This allows for the situation where during an ongoing discussion or an ongoing conversation, the participants respond to each other in brief intervals as with a conversation pause, e.g., a thinking pause including all participants in a conversation. Multiple speaking times can be captured simultaneously, each after the participant starts speaking in the conference, whereupon the start and end times of the speaking times of the participants can occur at different times.

While the first conversation pause time requires all of the participants in the conference to be silent, it is sufficient during the first speaking pause time for this first speaking pause time to have occurred when the respective speaking participant whose contribution is being captured stops speaking. The first speaking pause time should not result from a sentence spoken by the participant when a pause occurs between the individual words of the spoken sentence of a participant. Moreover, the first speaking pause time may only result when a spoken sentence is finished and no other spoken sentences immediately follow the finished sentence. Only the conversation being held in the conference has to stop during the first conversation pause time. Any potential background noise not originating from the participants in the conference and which can even drown out the sound from the conference conversation should not cause the conversation pause of the participants to fail to be captured because noise is present. The first conversation pause time and the first speaking pause time can be defined by the difference in volume between ambient noise and the speaking noise of the speaking participant being reached and/or exceeded. The corresponding parameters can be customized separately for the first conversation pause time and the first speaking pause time. The configuration of these parameters for the first conversation pause time and the first speaking pause time can be set and/or modified before the conference or during the conference.

In another embodiment, every conversation contribution of every speaking participant is captured as a speaking time assigned to every speaking participant, and a chronological conversation succession of the conversation of the participants held in the conference can be reconstructed from the chronological sequence of the time stamps. Capturing every conversation contribution from every speaking participant allows the complete course of conversation of the conversation held in the conference to be reconstructed, which makes it possible, in particular, to identify a participant barely taking part or even not taking part at all in the conversation held in the conference. This can be used to identify listeners in the conference that only make a minor contribution or even no contribution at all to the conversation held in the conference.

It is advantageous for the statistical data to be formed by correlating at least one speaking time assigned to a speaking participant regarding the chronological conversation succession with at least one speaking time assigned to another speaking participant. This allows consecutive contributions from different participants to be assigned to each other. Thus, participant pairs who spoke (to each other) in the conference in immediate conversation succession can be identified.

The statistical data generated by the statistical analysis of the speaking times of the participants can include the following information: Which participant spoke in immediate conversation succession with which other participants and for how long in the conference; which participant pairs spoke in immediate conversation succession and how often in the conference; which participants in the conference did not speak in immediate conversation succession; which participants spoke in the conference and for how long, whereupon the speaking times assigned to this participant are combined to a participant-based total speaking time that can be output as an absolute value or as a portion of the total conversation time of this participant based on the duration of the conference. The statistical data can include absolute values, i.e., a period or duration, e.g., in minutes and/or seconds, or a relative value, i.e., a period that is based on another period, e.g., a ratio formed from this period that can be displayed as a percentage.

In addition, the number of participant peers occurring in the conference that spoke in immediate conversation succession in the conference can be determined. If, for example, participant B responded to contributions from participant A multiple times, the number of these speaker changes in the conference can be captured and output, whereupon a speaker is considered to be a speaking participant. It can also capture and output how often participant A responded to contributions from participant B. The sequence of which participant contributed to the conversation of which other participants can be incorporated into the information included in the statistical data. Immediate conversation succession here means after a participant finished a contribution, the contribution of another participant immediately follows. This can occur when a speaking pause occurs between the contributions, no speaking pause occurs between the contributions, or the subsequent contribution begins before the end of the prior contribution. Alternately, immediate conversation succession can mean that a contribution of a participant follows the contribution of another participant. In this way, lower quality requirements can suffice for the automatic identification of every participant when the participant is speaking in the conference as with the case where multiple participants are speaking simultaneously and must be identified separately from each other.

It is advantageous for the statistical data to be able to be generated for a defined portion of time for the conference that is shorter than the duration of the conference. This can be used to help a user of the method according to the invention gain insight into a specific chronological portion of the duration of the conference regarding the statistical data to be generated. In particular, if every conversation contribution from every speaking participant has been captured, the defined portion of time for the conference can be selected for any portion of time from the start of the conference to its end.

This statistical data can be generated universally or to consider only a defined portion of time for the conference from the start of the conference in real time. In this case, the latest stopping time for the defined portion of time for generating the statistical data is the current conference time. The generated data in the form of the speaking times assigned to every speaking participant, which are each assigned a time stamp, and/or the statistical data generated from a statistical analysis of the speaking times of the participants can be made available in real time via a user interface on the terminal of a participant in the conference, e.g., as the individual time information. The speaking times and the statistical data can be generated by a conference server application. Alternately, individual or aggregate speaking times for individual participants can be queried from a conference archive collectively or selectively. In this case, the query of speaking times and/or statistical data occurs at a delay to the conference or after it is finished. A real-time view of the speaking times and/or statistical data is also called the online view, where a view of the speaking times and/or statistical data at a delay to the conference or after the end of the conference is called the offline view. The speaking times and/or statistical data can be output, forwarded, and/or saved. Optionally, the media flow of the conference, i.e., all of the data transmitted via the conference bridge and within the scope of the conference, e.g., voice data, image data, and/or text data, is output, forwarded, and/or saved together with the statistical data.

In another embodiment of the invention, the speaking time of the participant is assigned a specific business-related criterion, particularly a settlement account assigned to one of these participants. Alongside an individual speaking time for a participant, multiple speaking times and/or the statistical data for a specific business-related criterion can be assigned. A specific business-related criterion can be considered a settlement account or a cost center, in particular. An accounting application can also represent a business-related criterion. Other functions to further handle and/or process the speaking times and/or statistical data to capture the conversation contributions of a participant in the conference for cost purposes can form a specific business-related criterion. As described above, speaking times and/or statistical data that are generated with the method according to the invention can be assigned to the specific business-related criterion online or offline.

In another embodiment, the assignment of the speaking times of the participant to business-related criterion is triggered at a terminal unit by pressing a button, pressing a soft key on a user interface, or by a gesture recognized by gesture control. Alongside assigning an individual speaking time, multiple speaking times and/or statistical data can also be assigned to the specific business-related criterion by pressing a button, pressing a soft key, or via gesture control. The terminal unit can be assigned to a participant in the conference or a third party, e.g., an administrator or a conference organizer who is not taking part in the conference. An analysis of the speaking times and/or statistical data can take place immediately upon triggering on the terminal unit, i.e., in real time or online, or at a delay to the triggering, i.e., after triggering. As described above, the terminal unit can be a telephone terminal, a cellular phone, an IP phone, or a PC client. The user interface could, for example, be a touchscreen display on a PC monitor, telephone terminal, cellular phone, or a PDA (personal digital assistant). Other embodiments of a user interface are conceivable. A photocell on a cellular phone, a video camera or other visual equipment can be used to detect a gesture and analyze the gesture using gesture control. The gesture control can take place in the terminal unit itself or, with a sufficient transfer rate, in another device at a different location than the terminal unit.

It is advantageous for the speaking times and/or the statistical data on a terminal unit of the participant to be able to be output in real time. The output here can be handled by a conference application. The speaking times and/or the statistical data can be queried at a delay to the conference or after the end of the conference via a conference archive, as described above.

In another embodiment of the invention, the speaking times and/or the statistical data is forwarded to a superordinate business application for data analysis. Within the scope of forwarding the speaking times and/or statistical data to the superordinate business application, the speaking time of the participant can be assigned to a specific business-related criterion, as described above. The forwarding of speaking times and/or the statistical data to the superordinate business application for data analysis, as with outputting the speaking times and/or the statistical data, can be triggered at a terminal unit by pressing a button, pressing a soft key on a user interface, or by a gesture recognized by gesture control. The superordinate business application, e.g., a SAP module, can be implemented as a separate application from the conference application using a link in the conference application, or it can be integrated into the conference application itself. The forwarding of speaking times and/or the statistical data to the superordinate business application for data analysis, like outputting, forwarding, and/or saving this data in general, can take place via a user interface of the conference bridge to set up and manage the conference. The user interface of the conference bridge can be shown to a user by a conference bridge application.

It is also advantageous when information can be determined from the statistical data identifying which participant had the largest conversation contribution to the conversation in the conference, and this information can be analyzed, for example, by a presence-based rule engine, to decide whether rule-based call forwarding to a conversation partner should be enabled for this participant. The largest conversation contribution is considered the longest duration of totaled speaking times of a participant or the largest number of speaking times of a participant in a conference. Other definitions of the largest conversation contribution are conceivable, for example, if the duration of the totaled speaking times of a participant or the number of these speaking times of the participant is equal to that of another participant. Alternately, it is possible to determine, instead of the largest conversation contribution, the smallest or a small conversation contribution as information from the statistical data for a respective participant in a conference, and then analyze this information to allow a presence-based rule engine to decide whether rule-based call forwarding to a conversation partner should be enabled for this participant. A conversation partner is considered another participant in the conference or a supervisor of a conference participant. The forwarding of speaking times and/or the statistical data to the superordinate business application in the form of a presence-based rule engine can take place via a program interface of the conference bridge application. Before forwarding the speaking times and/or the statistical data to the superordinate business application, this data can be centrally and automatically captured on a server-based conference bridge application.

In another embodiment, data generated by another non-real-time collaboration service can be incorporated into generating the statistical data by the statistical analysis of the speaking times of the participants. This allows a statistical analysis of the speaking times of the participants, also called speaker-based time quotas, that takes place on real-time media servers to be extended to other centrally hosted non-real-time collaboration/conference services, e.g., an instant messaging or chat service. Data generated by another non-real-time collaboration service can be included in generating statistical data when the time basis for the conference is not used for the non-real-time collaboration service, and is replaced with a linear succession of the contributions of the participants in the non-real-time collaboration service, and a contribution time for each contribution is replaced with the number of characters that this contribution includes.

This case can arise when a “purely” non-real-time service that does not have its own time basis should be included. However, if the non-real-time collaboration service is supplementing the conference on a conference server, the non-real-time collaboration service as part of the conference session is based on the time basis of the conference. For example, a chat that takes place at the same time in parallel to a video conference can supplement this video conference as a non-real-time collaboration service, whereupon the time basis for the video conference is maintained. In this case, all of the services, including the chat, of the conference session are based on the time basis of the video conference as a shared time basis. This extension of the method according to the invention to non-real-time services allows the expansion of a purely voice conference server to a multimedia conference and collaboration server. The subsequent analysis of statistical data can take place identically to the case where data generated by a non-real-time collaboration service is not included in generating the statistical data. As with an instant messaging or chat service, the other non-real-time collaboration service can be centrally hosted.

All embodiments of the method according to the invention can proceed when the conference bridge is designed to be server-based. In this case, the conference is administered using a server, whereupon the conference is assigned a unique conference ID. A conference server can also record a conference in its full length. Due to the time basis running concurrently for the duration of the conference, which is used for the statistical analysis of the speaking times of the participants, i.e., the assignment of speaker and conversation time, aggregated speaking times for individual participants can be identified and selectively queried from a conference archive installed on the conference server. For example, all contributions from an individual participant, all conversations between specific participants, or even all aggregated contributions from the participants during a specific period of the conference can easily be queried via the conference server. By saving the media flow of the conference and the statistical data together on a conference server, this data can easily be analyzed together. This allows speaking times of individual participants to be totaled, for example, displayed as statistical data, and reviewed as reference data for the conference. Reference data is also called payload data, and it can include audio and/or video data, for example.

Alongside the speaking times for the participants in the conference, it is advantageous for analogous speaking times generated from the data of another non-real-time collaboration service to be able to be identified and aggregated on the conference server. As described above, the speaking time of a participant in a conference with a non-real-time collaboration service can correspond to the number of characters of a contribution within the scope of the non-real-time collaboration service or the duration of a contribution within the scope of the non-real-time collaboration service that is determined using the shared time basis. The portions of time that correspond to a conversation contribution in the conference or a contribution, e.g., in a chat, can be systematically identified since these are stored together on a conference server, and the portions corresponding to these contributions of the media flow of the conference and the non-real-time collaboration service can be selected and queried via the time basis of the conference.

The invention also covers a conference bridge for providing data produced in a conference, in which voice signals of participants in the conference can be mixed in the conference bridge with a time basis unit for providing a time basis running concurrently throughout the duration of the conference. The conference bridge also includes a speaker recognition unit to automatically identify every participant when this participant speaks in the conference, a conversation contribution recognition unit to capture a conversation contribution for each speaking participant for a conversion of the participants held in the conference as speaking time associated with each speaking participant in the conference, a time stamp assignment unit to assign a time stamp to the speaking time, and an analysis unit to generate statistical data with a statistical analysis of the speaking times.

The time basis unit, the voice recognition unit, the conversation contribution recognition unit, the time stamp assignment unit, and the analysis unit can be incorporated into the conference bridge individually or together physically, or physically separate from the conference bridge. In addition, these units or some of these units individually can be implemented as software, as hardware, or as a combination of hardware and software. Preferably, the conversation contribution recognition unit of the conference bridge includes a scheduling unit for setting a start time for the speaking time to a first time when a first participant starts speaking; setting a stop time for the speaking time to a second time when the first participant stops speaking when at least one of the following conditions is met: At the second time, the other participants are silent and a defined first conversation pause occurs after the second time that is as long as or longer than a first conversation pause time; at the second time, the other participants are silent and after the second time a second participant starts speaking within a second conversation pause that is shorter than the first conversation pause time; at the second time, a second participant speaks and after the second time, a speaking pause occurs for the first participant that is longer than the defined first speaking pause time. A conversation contribution recognition unit configured this way is an easy way to ensure that a conversation contribution of a participant can be reliably captured for a conversation held in a conference. It is advantageous for the conference bridge to be server-based, whereupon using a conference server for the conference bridge provides the advantages characterized by the corresponding method.

The method according to the invention and the conference bridge according to the invention can be used to capture with a concurrent time basis, statistically process, and make chronologically quantifiable the conversation contributions of participants in a conference and interactions between conversation partners in this conference, e.g., a voice conference or a video conference. Individual speaker-based contribution time quotas or contribution quotas for specific conversation successions can be identified and quantified. Contributions from participants in a session of a non-real-time collaboration service, e.g., instant messaging or chat, that is hosted in a conference session by a conference server can also be incorporated into the statistical analysis of the data for the conference. This allows interactions, e.g., shared conversation contributions, images, data, etc., of the participants in the conference and the session of a non-real-time collaboration/conference service with absolute and/or relative portions of time during the conference to be statistically analyzed.

Among other information, this statistical analysis enables the following information to be provided: Who spoke/interacted with whom for how long; who spoke/interacted for how long absolutely; who did not speak/interact at all. The statistical analysis also enables an integration and/or correlation, i.e., contextualization, of real-time and non-real-time interactions of the participants in the conference. The statistical analysis can take place in the conference bridge itself, e.g., in the form of a conference server application, or via program interfaces to a business application that can be separate from the conference server application. The portions of time the participants take part in the conversation in the conference and/or the resulting statistical data or a portion of it can be assigned to a dedicated settlement account or another business application.

According to embodiments of the invention, a terminal unit, e.g., a telephone terminal, a cellular phone, or a PC client, of a participant in a conference, e.g., a teleconference or videoconference, is used to execute the method according to the invention or one of its embodiments, whereupon the terminal unit generates a voice signal that can be mixed by a conference bridge.

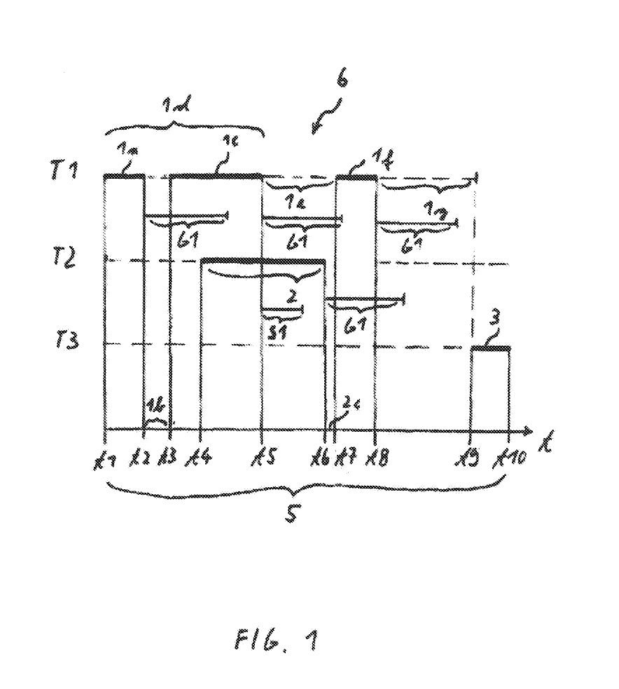

In FIG. 1, the chronological sequence 5 of a conference 6 is shown with three participants T1, T2, T3. The conference starts at time t1, proceeds through time t2 through t9 and ends at time t10. In FIG. 1, times t1 through t10 are plotted on a time bar t from left to right. All of the times t1 through t10 are referenced via a time basis that runs over the duration 5 of the conference 6. In the conference, a conversation is held with participants T1, T2, T3, whereupon individual contributions as speaking times 1a, 1c, 1f, 2, 3 of participants T1, T2, T3 are mixed in the form of voice signals in a conference bridge (not shown). In addition, in the scope of the conference, every participant T1, T2, T3 is automatically identified when this participant T1, T2, T3 speaks in the conference 6. It is assumed that participant T1 begins the conversation in the conference by starting a conversation contribution 1a at a time t1, and stopping at time t2. Since the participant T1 is automatically identified during his conversation contribution, e.g., via a speaker recognition unit, the contribution of participant T1 to the conversation held in the conference 6 is detected as speaking time 1a. At the time t2, the participant T1 stops speaking, whereupon a speaking pause 1b of the participant T1 immediately follows at the time t2. At the time t2, the other participants T2, T3 remain silent, and the duration of the speaking pause 1b of the participant T1 is shorter than a defined first conversation pause time G1. The speaking pause 1b of the participant T1 lasts, for example, for 1 to 10 seconds, preferably 1 to 5, and even more preferable, 1 to 3 seconds. The first conversation pause time G1 lasts, for example, for 10 to 20 seconds, preferably 5 to 10 seconds, and even more preferable, 3 to 7 seconds. Other times are possible for the first conversation pause time.

Since the speaking pause 1b of the participant T1 is shorter than the first conversation pause time, no stop time is set for the detected conversation contribution of the participant T1, even though he stopped speaking for the time 1b. At the time t3, the participant T1 starts speaking again, and the second contribution of the participant T1, the speaking time 1c, stops at the time t5. As the time t5 that the speaking time 1c of the participant T1 stops, the participant T2 is speaking, since he started speaking at the time t4, between t3 and t5. After the time t5, the participant T1 remains silent until the time t7 for the duration 1e. Since the duration of the speaking pause 1e of the participant T1 is longer than a defined first speaking pause time S1, the time t5 is detected as the end of the contribution 1a, 1c of the participant T1, even though the speaking pause 1e is shorter than the first conversation pause time G1.

Since another participant, namely T2, spoke at the time t5, the condition occurring at the time t2 does not apply, since no other participants spoke at that time. Since the participant T2 spoke at the time t5, the end of the contribution of participant T1 is detected using the first speaking pause time S1 and not using the first conversation pause time G1. Therefore, according to this embodiment of the invention, the contribution of the participant T1 is detected with a speaking time 1d, which spans from t1 through t5, even though this participant T1 did not speak between t2 and t3. The contribution of the participant T2, who started at the time t4, stops at the time t6. At this time, all of the other participants are silent, and the participant T1 starts speaking again at the time t7. Since the conversation pause 2c, starting at the time t6 and stopping at the time t7, has a duration shorter than the first conversation pause time G1, the stop time of speaking time 2 of the participant T2 is set at the time t6. The speaking time 2 of the participant T2 is thus detected over the time period t4 to t5, when both the participants T1, T2 were speaking, as well as the time period between t5 and t6, when only the participant T2 was speaking. The first speaking pause time S1 can have values of less than one second, 1 to 3 or 1 to 5 seconds. Other values are possible for the first speaking pause time S1.

The contribution of the participant T1, starting at the time t7, ends at the time t8, and after this time, a conversation pause 1g follows. Since the duration of the conversation pause 1g is longer than the duration of the first conversation pause time G1, the time t8 is detected as the stop time of the contribution 1f of the participant T1.

The third participant T3 starts his contribution at the time t9. Since the duration of the conversation pause 1g is longer than the first conversation pause time G1, the time t8 is detected as the stop time of the speaking time 1f of the participant T1. Had the third participant T3 began his contribution 3 at a time before the end of the first conversation pause time, the time t8 would still have been detected as the stop time of the contribution 1f of the participant T1. The reason for this is that the other participants T2, T3 were silent at the time t8, and after the second time, the participant T3 would have begun speaking within a conversation pause that would have been shorter than the first conversation pause time G1.

In this way, contributions according to embodiments of the invention are detected for the conversation held in the conference 6 by the participants T1, T2, T3, whereupon the contribution of the participant T1 is detected as speaking time 1d, which includes the speaking times 1a, 1c and the conversation pause 1b. In addition, the speaking time 2 of the participant T2, the contribution 1f of the participant T1, and the contribution 3 of the participant T3 are detected.

In addition to detecting the speaking times 1d, 1f, 2, 3 of the participants T1, T2, T3, every detected contribution 1d, 1f, 2, 3 is each assigned a time stamp t1, t7, t4, t9. For example, the speaking time 1d of the participant T1 is assigned the time stamp t1. In addition, the speaking time 1f of the participant T1 is assigned the time stamp t7. Finally, the contribution of the participant T2 as the speaking time 2 is assigned the time stamp at the time t4, and the speaking time 3 of the participant T3 is assigned the time stamp at the time t9.

Statistical data is then generated with a statistical analysis of the speaking times 1d, 1f, 2, 3 of the participants T1, T2, T3. To construct a chronological conversation succession of the conversation held in the conference 6 by the participants T1, T2, T3 from the chronological sequence of the time stamps t1, t4, t7, t9, every speaking time 1d, 1f, 2, 3 of every speaking participant T1, T2, T3 is detected as speaking times 1d, 1f, 2, 3 assigned to every speaking participant T1, T2, T3. This makes it possible to statistically determine that the speaking time 2 of the participant T3 followed the speaking time 1d of the participant T1, even though the speaking time 1d of the participant T1 was not finished at the start of the speaking time 2 of the participant T2. This can be used to form a participant pair T1, T2, which spoke in immediate conversation succession t1, t4 in the conference 6. This allows the statistical data to be formed by correlating at least one speaking time 1d, 1f assigned to a speaking participant T1 regarding the chronological conversation succession with at least one speaking time 2 assigned to another speaking participant T2.

The participants' individual speaking times 1d, 1f, 2, 3 can alternately be used to determine which participants T1, T2, T3 spoke in the conference 6 and for how long. For example, the statistical analysis can show that the participant T1 spoke for the duration of the speaking times 1d and 1f in the conference 6. By totaling the speaking times 1d, 1f assigned to the participant T1, an absolute value is generated in the statistical analysis, and it is alternately or additionally possible to output this participant-based total speaking time 1d, 1f as a portion of the total conversation time for participant T1 based on the duration 5 of the conference 6.

In addition, the statistical analysis of the speaking times 1d, 1f, 2, 3 of the participants T1, T2, T3 show that the participant T1 spoke twice in immediate succession in the conference 6. The first time, the participant T1 spoke at the time t1, and the second time was at the time t7. When detecting every conversation contribution for every speaking participant T1, T2, T3, the statistical analysis can also indicate whether a participant T1, T2, T3 in the conference 6 did not speak in immediate conversation succession. The chronological course of FIG. 1 consequently shows that every participant T1, T2, T3 made a contribution to the conversation in the conference 6 in a manner in which no participant in the conference 6 did not speak in immediate conversation succession.

The statistical data resulting from the statistical analysis of the speaking times 1d, 1f, 2, 3 of the participants T1, T2, T3 does not have to be collected for the duration 5 of the conference 6. It is sufficient to collect the statistical data, for example, from the time period t1 to t5. In this case, the speaking time of the participant 2 does not span from t4 to t6, but rather only from t4 to t5. The data for the speaking time 3 of the participant T3 and the speaking time 1f of the participant T1 are not included in an examination of the time window t1 to t5.

Alongside the information on the statistical data of which participants T1, T2, T3 spoke in immediate conversation succession with which other participants T1, T2, T3 for how long 1d, 1f, 2, 3 in the conference, which participant pairs T1, T2 spoke in immediate conversation succession in the conference 6 and how often (once), which participants T1, T2, T3 did not (none) speak in immediate conversation succession in the conference 6, and which participants T1, T2, T3 spoke in the conference for how long 1d, 1f, 2, 3, individual speaking times 1d, 1f of a participant T1 are also included. In this respect, the speaking times 1d, 2, 1f, 3 assigned a time stamp t1, t4, t7, t9 of the participants T1, T2, T3 already represent statistical data.

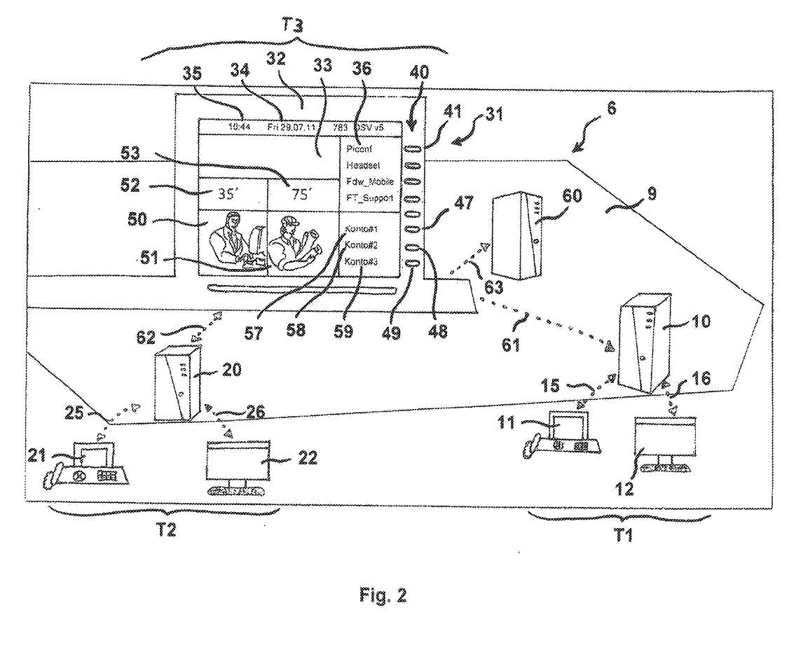

FIG. 2 shows the layout for a conference 6 with the participants T1, T2, T3. The conference 6 is switched in a data network 9 by a conference bridge 60. The data network 9 can be an intranet or the internet. The conference bridge 60 can run on a conference server, whereupon the conference bridge comprises a conference bridge application, also known as a conference application. In this case, the conference bridge 60 comprises software in the form of a conference application, whereupon the conference server acts as the hardware of the conference bridge 60.

The participant T1 is connected with the conference bridge 60 via a terminal unit 11 and/or a monitor 12, also known as a display, a connection unit 10, and a terminal unit 31. To achieve this, there is a data connection 15 between the terminal unit 11 and the connection unit 10, another data connection 16 between the monitor 12 and the connection unit 10, a data connection 61 between the terminal unit 31 and the connection unit 10, and a data connection 63 between the terminal unit 31 and the conference bridge 60. With the conference bridge designed as a conference application on a conference server, the connection unit 10 can act as a client to the conference server.

The terminal unit 11 can be a telephone terminal, a cellular phone, and IP phone, or a PDA. The monitor 12 can be a flat-screen monitor in the form of a TFT (thin film transistor) display, a plasma display, or a conventional CRT (cathode ray tube) display. The data connections 15, 16, 61, and 63 can be packet-switching data transmission lines. For example, the data network 9 could be the internet, with the data being transmitted between the terminal unit 11 and/or the monitor 12, and the conference bridge 60 via the TCP/IP protocol. A part of the transmission path between the terminal unit 11 and/or the monitor 12, and the conference bridge 60 can take place via a circuit-switching network.

Another participant T2 is connected to the conference bridge 60 similarly to the participant T1. The participant T2 has a terminal unit 21, e.g., in the form of a telephone terminal, cellular phone, or PDA, and/or a monitor 22, e.g., in the form of a flat-screen display or a CRT display, whereupon the terminal unit 21 is connected to another connection unit 20 via the data line 25 and the monitor 22 is connected to this connection unit 20 via the data line 26. The connection unit 20 is connected to the terminal unit 31 of a third participant T3 via a data line 62, which is, in turn, connected to the conference bridge 60 via the data line 63. With the conference bridge designed as a conference application on a conference server, the connection unit 20 can act as a client. This client can be installed on a computer, i.e., a PC.

The participant T3 with the terminal unit 31 is directly connected to the conference bridge 60 via the data line 63. The terminal unit 31 can be an IP phone, i.e., an OpenStage phone, which is connected to a conference server using an XML-based client-server architecture, for example, on which the conference bridge 60 is installed. The terminal unit 31 includes a pivoting panel 32 with a display 33, and the display 33 can be designed as a touchscreen. The top section of the display 33 shows the system time 35 and the date 34 in the form of the weekday and the date, specifying the month, day, and year. Next to this is a panel 32 with buttons 40 that can be designed as touch-sensitive buttons. The function assigned to each button 40 is determined by the configuration of each button, which is shown on the display 33. For example, the button 41 has the function “Piconf,” which automatically assigns a current image to a participant T1, T2, T3 recognized using the voice of the participant T1, T2, T3. The button 41 is thus what is known as a soft key, which can be assigned different functions depending on the what is indicated on the on-screen display 33. A soft key can also be shown on the display 33, e.g., when the display 33 is designed as a touchscreen. In this case, the function of assigning a current image to a speaker could be performed by tapping on “Piconf” on the display 33. This assumes that the assignment of an image to a speaking participant T1, T2, T3 in the conference 6 takes place, whereupon the participant T1 is assigned the image 50 and the participant T2 is assigned the image 51, and this is shown on the display 33.

According to the invention, this totals the speaking times assigned to a participant T1, T2, T3, and shows this information on the display 33 of the terminal unit 31 as an absolute value in minutes. For example, the participant T1, who is shown as image 50 on the display 33, has an aggregated total speaking time of 35 minutes as shown in the form of the reference 52 above the image 50 of the participant T1 on the display 33. Similarly, the participant T2, who is shown as image 51 on the display 33, has an aggregated total speaking time of 75 minutes as shown as shown on the indicator 53 above the image 51 on the display 33. The indicators 52, 53 of the portion of conversation time for a participant T1, T2, T3 in the form of a participant-based total speaking time can be switched by pressing a button, e.g., with a soft key.

The indicator can be real-time, e.g., when the terminal unit is designed as a telephone terminal or PC client that has direct access to the conference application that visualizes the automatic identification of the speaking participant T1, T2, T3. The activation via a button can also take place via other technical triggers, e.g., a gesture detected by a gesture recognition unit. The display 33 forms a user interface for the participant T3, where a conference ID, for example, can be displayed as an identifier of a specific conference 6. The total duration 5 of the conference can also be shown on the display 33, and the statistical analysis information on the speaking times of participants T1, T2, T3 can be broken down.

The term 57 “Account#1” is also assigned to the soft key 47 as a function on the display 33. Similarly, the term 58 “Account#2” is assigned to the soft key 48, and the term 59 “Account#3” is assigned to the soft key 49. The soft keys 47 through 49 can assign the detected total speaking times 52, 53 to different accounts. For example, the total speaking time 52 of 35 minutes for the participant T1 can be assigned to the settlement account “Account#1” by pressing the soft key 47. Similarly, a speaking time for the participant T2 can be assigned to the settlement account “Account#2” by pressing the soft key 48. The participant T3 can assign his own speaking times to his settlement account “Account#3” by pressing the button 49. The settlement accounts 57, 58, 59 are represented by a superordinate business application, to which the speaking times of the participants T1, T2, T3 can be forwarded as speaking times and/or statistical data for data analysis via a program interface when the conference bridge is designed as a conference application.

It is possible to have other business-related criterion for data analysis of the speaking times of the participants T1, T2, T3. As described above, a speaking time of the participant T1, T2, T3 is assigned on the terminal unit 31 by pressing a button 47, 48, 49, pressing a soft key on a user interface of the display 33, by a gesture detected by gesture control, or by clicking a mouse. After analyzing the statistical data with an analysis of the speaking times of the participants T1, T2, T3, information can be determined by pressing one of the soft keys 40 on the terminal unit 31 regarding which participant T1 made the largest conversation contribution in the conference 6, whereupon this information is analyzed by a superordinate business application in a way that a presence-based rule engine can decide whether this participant T1 should be allowed rule-based call forwarding to a conversation partner. This decision can be made immediately after the end of the conference 6, or even during the conference 6, i.e., in real time. With the server-based design of the conference bridge 60, it is easy to also incorporate data from another non-real-time collaboration service, e.g., a centrally hosted instant messaging or chat service, into the analysis of the statistical data with the statistical analysis of the speaking times of the participants T1, T2, T3.

If the data generated by the non-real-time collaboration service cannot be based on the time basis 35 of the conference 6, it is possible for the time basis 35 to be replaced by a linear succession of the contributions of the participants T1, T2, T3 in the session of the non-real-time collaboration service, and replace a contribution time for every contribution of the participants T1, T2, T3 in the session of the non-real-time collaboration service with a number of characters included in this contribution.

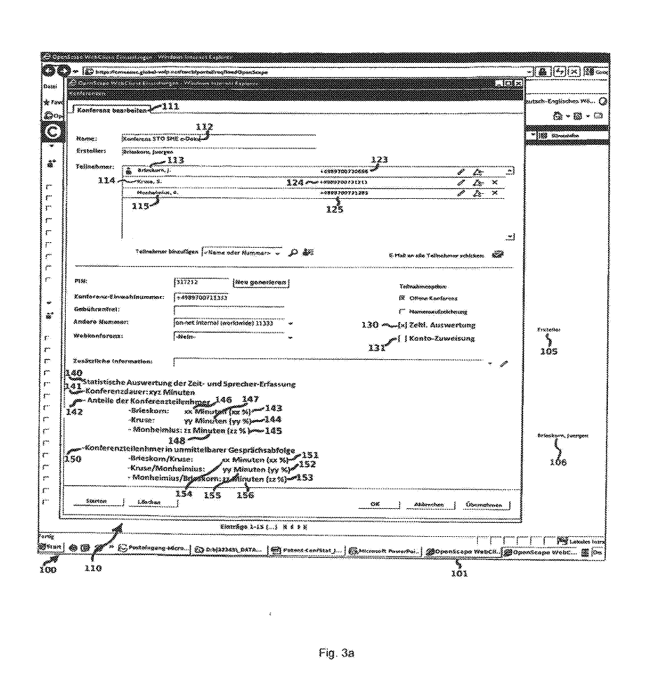

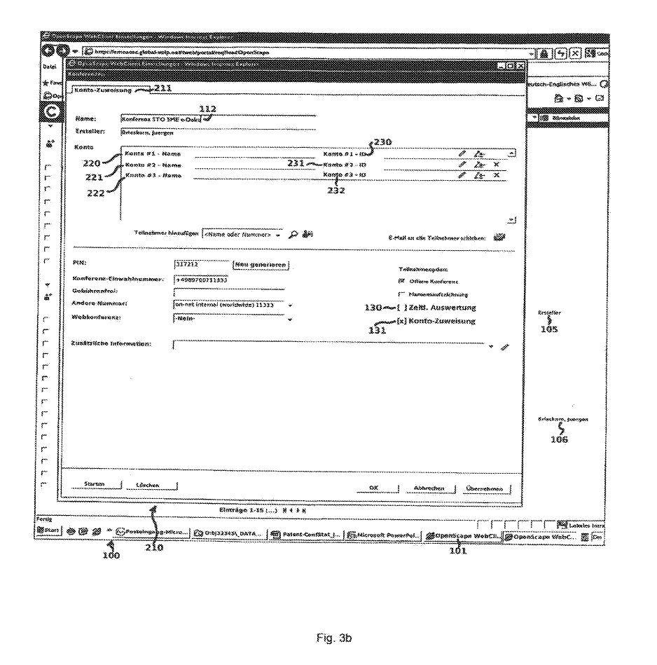

FIG. 3a shows a user interface 100 for a conference application with enhanced administration and analysis functions. An “OpenScape Web Client” 101 is used on a PC as the conference application. The user interface 100 includes the option of combining different participants 106 that can each appear as the creator 105 of a conference 6 into one conference 6. The conference application “OpenScape Web Client” can be used to define and edit the type and number of soft keys 40 that are shown in FIG. 2.

The conference bridge 60 provides a user interface 110 to set up and administer the conference 6. The conference 6 is assigned a unique conference ID 112 that can be used to identify the statistical data assigned to this conference 6 from the statistical analysis of the speaking times of the participants T1, T2, T3. In addition, the conference ID 112 can be used to assign, select and query a media flow of the conference 6 corresponding to the speaking times of the participants T1, T2, T3 for these speaking times. According to the user interface 110, the conference 6 includes the names 113, 114, 115 of the participants that can be reached using the telephone numbers 123, 124, 125. A chronological analysis 130 is activated, and this chronological analysis is designed as a statistical analysis of the time and speaker recognition 140. Alongside an indicator 141 of the total conference duration 5 in minutes, the chronological analysis also includes the option of an indicator 142 of portions of the conference participants in the conference 6.

For example, the participant “Brieskorn” has a total speaking time of XX minutes 146 as a portion of the conference participants in the conference 6. In addition, the portion of conversation time of the participant “Brieskorn” in the conference 6 is shown as a percentage 143. Another participant in the conference, “Kruse,” has a chronological portion of the conversation of YY minutes 147 in the conference, which corresponds to a percentage of YY 144. The last participant, “Monheimius,” has a chronological portion of the conversation of ZZ minutes 148, corresponding to a percentage of ZZ 145 in the conference 6. The user interface 110 also shows participant pairs in immediate conversation succession as conference participants in immediate conversation succession 150. The first participant pair “Brieskorn/Kruse” spoke in immediate conversation succession XX minutes 154, corresponding to a percentage of XX 151 in the conference 6. In addition, the participant pair “Kruse/Monheimius” had a portion of the conversation 155 of YY minutes for the conference 6, corresponding to a percentage 152. Finally, the participant pair “Monheimius/Brieskorn” had a portion of the conversation 156 in minutes for the conference 6, corresponding to a percentage “ZZ” 153.

FIG. 3b shows, both the user interface 100 of the conference application “OpenScape Web Client,” where the participants 106, who can appear as the creator 105 of a conference 6, can be combined into a conference 6, and a user interface 210 for administration in the event of an active account assignment. Alongside the name 112 of the conference 6 in the form of a conference ID, the account assignment 221 is carried out by clicking the corresponding function 131 under the heading “Participation options.”

The settlement accounts for the participants in the conference 6 each have a name 220, 221, 222, whereupon each account is assigned an account ID. Thus, the account “#1” is assigned an account ID 230, the account “#2” is assigned the account ID 231, and the account “#3” is assigned the account ID 232. This allows the administrator of the conference 6 to assign different account IDs to different accounts. An account, for example, could be either a settlement account or a cost center. The account management for the accounts with the names 220, 221, 222 and the account IDs 230, 231, 232 does not have to be handled by an application that is part of the conference application 101. Moreover, it is also possible to run a business application for account management of the accounts 220, 221, 222 that can be executed separately from the conference application, and only show a representation of this business application on the user interface 210. This can be done, for example, with a link between the conference application and the business application. Alongside the account assignment 131 as shown on the user interface 210, the same user interface 210 can also be used to generate a chronological analysis 130, as shown in FIG. 3a.

This invention makes it possible by detecting individual conversation contributions, to which the respective participant providing this contribution and a time stamp are assigned, to reconstruct the course of the conversation, and the conversation succession for a conference. This can provide a series of value-added functions with a statistical analysis of these speaking times to the participants of the conference and/or the superordinate business application.

1-21. (canceled)

22. A method of collecting conference call data based on voice signals received via at least one network from terminal devices of conference call participants, the method comprising:
a conference server receiving the voice signals from the terminal devices via the network during the conference call, the conference server comprising hardware;
the conference server recognizing a first participant of the conference call based on the received voice signals and assigning a first time stamp to a first time segment of the conference call;
in response to detecting that the first participant and all other participants to the conference call do not speak for a fixed talk delay period after the assignment of the first time stamp during the first time segment, the conference server assigning a second time stamp to define a first time stop of the first time segment of the conference call, the first and second time stamps defining a start and end of the first time segment in which the recognized first participant spoke during the conference call;
the conference server recognizing the second participant of the conference call based on the received voice signals and assigning a third time stamp to a second time segment of the conference call;
in response to detecting that the second participant and all the other participants to the conference call do not speak for the fixed talk delay period after the assignment of the third time stamp during the second time segment based on the received voice signals, the conference server assigning a fourth time stamp to define a second time stop of the second time segment of the conference call, the third and fourth time stamps defining a start and end of the second time segment in which the recognized second participant spoke during the conference call; and
during the second time segment, the conference server recognizing a first speech pause that is shorter than the fixed talk delay period, the first speech pause being a duration of time in which the second participant is not speaking, a duration of the first speech pause being included within the second time segment and assigned as a portion of time during the conference that the second participant spoke during the conference;
the conference server performing statistical analysis based on the assigned first, second, third, and fourth time stamps and the first speech pause to generate statistical data that identifies a duration of time the first participant has spoken during the conference call and that identifies a duration of time the second participant has spoken during the conference call.

23. The method of claim 22, wherein each of the terminal devices is a cellular phone, a telephone, a personal computer, or a personal digital assistant; and
wherein the conference server is a conference bridge.

24. The method of claim 22, further comprising:
during the first speech pause of the second time segment, the conference server detecting a third participant of the conference call based on the received voice signals and assigning a fifth time stamp for a third time segment of the conference call;
in response to detecting that the third participant does not speak for the fixed talk delay period after the assignment of the fifth time stamp based on the received voice signals, the conference server assigning a sixth time stamp to define a third time stop for a third time segment of the conference call that is associated with a third time segment of the conference call in which the third participant spoke during the conference call.

25. The method of claim 24, wherein the third time stop is assigned when the conference server detects that the third participant and all the other participants of the conference call did not speak for the fixed talk delay period after the fifth time stamp was assigned.

26. The method of claim 24, wherein the conference server performs the statistical analysis during the conference call, and the method also comprising:
the conference server communicating data to a terminal device of the first participant based on the performed statistical analysis;
the terminal device of the first participant generating at least one graphic to identify the duration of time the first participant has spoken during the conference call, the duration of time the second participant has spoken during the conference call and the duration of time the third participant has spoken during the conference call via a display device of the terminal device or a display connected to the terminal device based on the data communicated to the terminal device of the first participant by the conference server.

27. The method of claim 22, comprising:
the conference server recognizing a third participant of the conference call based on the received voice signals and assigning a fifth time stamp to a third time segment of the conference call;
in response to detecting that the third participant does not speak for a third pre-selected time period after the assignment of the fifth time stamp during the third time segment while a fourth participant is detected as speaking during the third pre-selected time period, the conference server assigning a sixth time stamp to define a third time stop of the third time segment of the conference call, the fifth and sixth time stamps defining a start and end of the third time segment in which the recognized third participant spoke during the conference call;
the conference server recognizing the fourth participant of the conference call based on the received voice signals and assigning a seventh time stamp to a fourth time segment of the conference call; and
in response to detecting that the fourth participant does not speak for a fourth pre-selected time period after the assignment of the seventh time stamp during the fourth time segment based on the received voice signals, the conference server assigning an eighth time stamp to define a fourth time stop of the fourth time segment of the conference call, the seventh and eighth time stamps defining a start and end of the fourth time segment in which the recognized fourth participant spoke during the conference call.

28. The method of claim 27, comprising:
the conference server performing the statistical analysis based on the assigned fifth, sixth, seventh, and eighth time stamps to generate statistical data that identifies a duration of time the third participant has spoken during the conference call and that identifies a duration of time the fourth participant has spoken during the conference call.

29. The method of claim 28, comprising:
the conference server communicating data to a terminal device of the first participant based on the performed statistical analysis;
the terminal device of the first participant generating at least one graphic to identify the duration of time the first participant has spoken during the conference call, the duration of time the second participant has spoken during the conference call, the duration of time the third participant has spoken during the conference call, and the duration of time the fourth participant has spoken during the conference call via a display device of the terminal device or a display connected to the terminal device;
the conference server communicating data to a terminal device of the second participant based on the performed statistical analysis; and
the terminal device of the second participant generating at least one graphic to identify the duration of time the first participant has spoken during the conference call, the duration of time the second participant has spoken during the conference call, the duration of time the third participant has spoken during the conference call, and the duration of time the fourth participant has spoken during the conference call via a display device of the terminal device or a display connected to the terminal device based on the data communicated by the conference server.

30. The method of claim 29, wherein the conference server performs the statistical analysis during the conference call.

31. The method of claim 22, comprising:
the conference server communicating with a non real-time collaboration service during the conference call.

32. The method of claim 31, wherein the non real-time collaboration service is an instant messaging service or a chat service.

33. The method of claim 32, comprising:
the conference server incorporating data generated by the non real-time collaboration service into the statistical analysis performed by the conference server.

34. The method of claim 22, wherein the assignments of the first time stamp and the third time stamp are each in response to receipt of input received via an input device.

35. The method of claim 34, wherein the input device is a button or a soft key of a user interface of a terminal device communicatively connected to the conference server via the network, and a gesture recognized by a gesture control communicatively connected to the conference server via the network.

36. The method of claim 22, comprising:
the conference server performing statistical analysis based on the assigned first, second, third, and fourth time stamps and the first speech pause to determine which participant of the conference call had a largest conversation contribution to the conference call.

37. The method of claim 36, comprising:
the conference server assigning a rule-based call forwarding for the first participant in response to determining that the first participant had the largest conversation contribution.

38. The method of claim 22, comprising:
the conference server performing chronological conversation analysis based on the received voice signals and the first, second, third, and fourth time stamps.

39. The method of claim 38, comprising:
the conference server generating data to communicate to at least one terminal device based on the performed chronological conversation analysis that is configured for generation of a display identifying a chronological sequence of speaking times for the conference call.

40. The method of claim 22, comprising:
assigning the first and second time segments to different accounts.

41. A conference server comprising hardware, the conference server configured to perform the method of claim 22.
